(19) United States
(12) Patent Application Publication
(10) Pub. No.: US 2025/0236164 A1
(43) Pub. Date: Jul. 24, 2025

(54) VEHICLE

(71) Applicant: TOYOTA JIDOSHA KABUSHIKI KAISHA, Toyota-shi (JP)

(72) Inventors: Kazuki SUGIE, Miyoshi-shi (JP); Akio MORI, Toyota-shi (JP); Yoshiro KAMO, Kanagawa-ken (JP); Takahiko NAKANO, Nagoya-shi (JP); Toshihiro SHIMONAKA, Toyota-shi (JP); Kenichi KOHASHI, Shizuoka-ken (JP); Yuki SODA, Nagoya-shi (JP)

(73) Assignee: TOYOTA JIDOSHA KABUSHIKI KAISHA, Toyota-shi (JP)

(21) Appl. No.: 18/987,232

(22) Filed: Dec. 19, 2024

(30) Foreign Application Priority Data
Jan. 19, 2024 (JP) 2024-006699

(51) Int. Cl. B60K 1/04; B60L 50/60; B60L 50/64

(52) U.S. Cl. CPC B60K 1/04; B60L 50/64; B60L 50/66; B60K 2001/0438

(57) ABSTRACT

A first power storage module includes a first power storage cell. A second power storage module includes a second power storage cell. The second power storage module is disposed on the first power storage module. The first power storage module is disposed between a first frame and a second frame. The first power storage cell includes a first end surface and a second end surface which are arranged, spaced apart from each other in a width direction of a vehicle, and a first external terminal provided at the first end surface. The second power storage cell includes a third end surface and a fourth end surface which are arranged, spaced apart from each other in a front-rear direction of the vehicle, and a second external terminal provided at the third end surface.

### CROSS REFERENCE TO RELATED APPLICATIONS

This nonprovisional application is based on Japanese Patent Application No. 2024-006699 filed on Jan. 19, 2024 with the Japan Patent Office, the entire content of which is hereby incorporated by reference.

### BACKGROUND

### Field

The present disclosure relates to a vehicle.

### Description of the Background Art

Japanese Patent Laying-Open No. 2020-205198 discloses a vehicle that includes a power storage device in which power storage modules are stacked in the up-down direction of the vehicle.

### SUMMARY

In the vehicle disclosed in Japanese Patent Laying-Open No. 2020-205198, when the power storage device and the vehicle frame are viewed from a side of the vehicle, some of the power storage modules of the power storage device do not overlap a frame disposed at the bottom of the vehicle frame. Such a vehicle is required to protect the power storage modules that are not overlapping the frame disposed at the bottom of the vehicle frame when the power storage device and the vehicle frame are viewed from a side of the vehicle.

An object of the present disclosure is to protect power storage modules, stacked in a power storage device of a vehicle in the up-down direction of the vehicle, which are not overlapping the frame disposed at the bottom of the vehicle frame when the power storage device and the vehicle frame are viewed from a side of the vehicle.

A vehicle according to a certain aspect of the present disclosure includes a vehicle frame; and a power storage device provided on the vehicle frame. The vehicle frame includes a first frame and a second frame which is disposed, spaced apart from the first frame in a width direction of the vehicle. The first frame and the second frame extend in a front-rear direction of the vehicle. The power storage device includes a first power storage module which includes a first power storage cell, and a second power storage module which includes a second power storage cell, the second power storage module being disposed on the first power storage module. The first power storage module is disposed between the first frame and the second frame. The first power storage cell extends in the width direction of the vehicle. The first power storage cell includes a first end surface and a second end surface, which are arranged, spaced apart from each other in the width direction of the vehicle, and a first external terminal provided at the first end surface. The second power storage cell extends in the front-rear direction of the vehicle. The second power storage cell includes a third end surface and a fourth end surface, which are arranged, spaced apart from each other in the front-rear direction of the vehicle, and a second external terminal provided at the third end surface.

The vehicle frame includes: a first pillar connected to the first frame; a second pillar disposed behind and spaced apart from the first pillar and connected to the first frame; and a third pillar disposed behind and spaced apart from the second pillar and connected to the first frame. When the second power storage module and the vehicle frame are viewed from a side of the vehicle, a front end portion of the second power storage cell overlaps the second pillar.

The vehicle frame includes: a first pillar connected to the first frame; a second pillar disposed behind and spaced apart from the first pillar and connected to the first frame; and a third pillar disposed behind and spaced apart from the second pillar and connected to the first frame. When the second power storage module and the vehicle frame are viewed from a side of the vehicle, a rear end portion of the second power storage cell overlaps the third pillar.

The first power storage cell and the second power storage cell have a same size.

The first power storage cell further includes a first exhaust valve provided in the first end surface. The second power storage cell further includes a second exhaust valve provided in the third end surface.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a side view schematically showing a vehicle according to an embodiment according to the present disclosure.

FIG. 2 is a perspective view schematically showing a vehicle frame 3.

FIG. 3 is a first perspective view schematically showing a power storage device 2.

FIG. 4 is a second perspective view schematically showing the power storage device 2.

FIG. 5 is a diagram schematically showing the vehicle frame 3 and the power storage device 2 secured to the vehicle frame 3, as viewed from the front of the vehicle 1.

FIG. 6 is a diagram schematically showing the vehicle frame 3 and the power storage device 2 secured to the vehicle frame 3, as viewed from the top (in a direction D4 shown in FIG. 3).

FIG. 7 is a diagram schematically showing one example of power storage cells 51.

FIG. 8 is a diagram schematically showing one example of power storage cells 61.

### DESCRIPTION OF THE PREFERRED EMBODIMENTS

Hereinafter, embodiments and variations thereof according to the present disclosure are described, with reference to the accompanying drawings. In the following description, like reference signs refer to like parts and components. Their names and functionalities are also the same. Thus, detailed description thereof will not be repeated. Note that the embodiments and variations thereof described below may be selectively combined as appropriate.

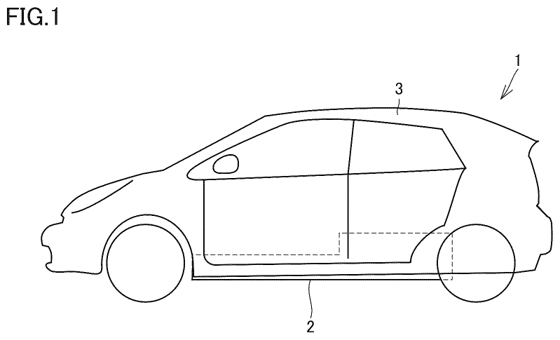

Referring to FIGS. 1 to 8, a vehicle according to the present embodiment is now described. FIG. 1 is a side view schematically showing the vehicle according to an embodiment according to the present disclosure. A vehicle 1 according to the embodiment according to the present disclosure is, for example, a battery electric vehicle that can be driven by a motor, or an electric-powered vehicle such as a hybrid electric vehicle. The vehicle 1 includes a power storage device 2 and a vehicle frame 3. The power storage device 2 includes batteries storing electric power to be supplied to the motor. The power storage device 2 is disposed on the bottom surface of the vehicle 1.

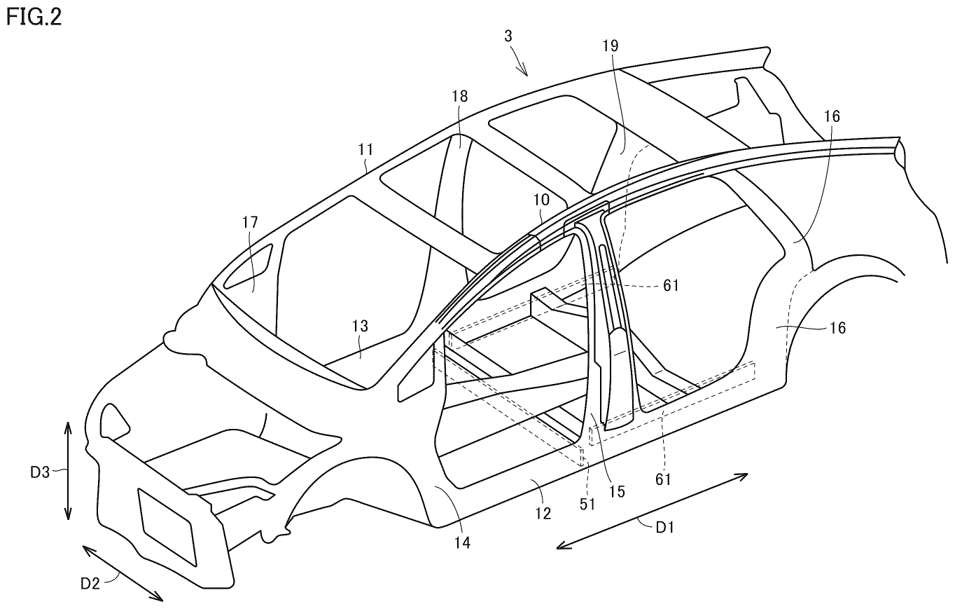

FIG. 2 is a perspective view schematically showing the vehicle frame 3. The vehicle frame 3 includes a left roof rail 10, a right roof rail 11, a left frame 12, a right frame 13, a first left pillar 14, a second left pillar 15, a third left pillar 16, a first right pillar 17, a second right pillar 18, and a third right pillar 19.

The left roof rail 10 and the right roof rail 11 are disposed atop the vehicle frame 3. The left roof rail 10 and the right roof rail 11 are disposed, spaced apart from each other in a width direction D2 of the vehicle 1. The left roof rail 10 and the right roof rail 11 extend in a front-rear direction D1 of the vehicle 1.

The left frame 12 is one example of a “first frame” according to the present disclosure. The right frame 13 is one example of a “second frame” according to the present disclosure. The left frame 12 and the right frame 13 are disposed on the bottom of the vehicle frame 3. The left frame 12 and the right frame 13 are disposed, spaced apart from each other in a width direction D2 of the vehicle 1. The left frame 12 and the right frame 13 extend in the front-rear direction D1 of the vehicle 1.

The first left pillar 14, the second left pillar 15, and the third left pillar 16 are disposed on a left surface of the vehicle frame 3. The first left pillar 14 is arranged to connect the front end of the left frame 12 and the front end of the left roof rail 10. The second left pillar 15 is arranged to connect the center portion of the left frame 12 and the center portion of the left roof rail 10. The third left pillar 16 is arranged to connect the rear end of the left frame 12 and the rear portion of the left roof rail 10. In other words, the second left pillar 15 is disposed behind and spaced apart from the first left pillar 14. The third left pillar 16 is disposed behind and spaced apart from the second left pillar 15.

The first right pillar 17, the second right pillar 18, and the third right pillar 19 are disposed on a right surface of the vehicle frame 3. The first right pillar 17 is arranged to connect the front end of the right frame 13 and the front end of the right roof rail 11. The second right pillar 18 is arranged to connect the center portion of the right frame 13 and the center portion of the right roof rail 11. The third right pillar 19 is arranged to connect the rear end of the right frame 13 and the rear portion of the right roof rail 11. In other words, the second right pillar 18 is disposed behind and spaced apart from the first right pillar 17. The third right pillar 19 is disposed behind and spaced apart from the second right pillar 18.

The first left pillar 14 and the first right pillar 17 are each one example of a “first pillar” according to the present disclosure. The second left pillar 15 and the second right pillar 18 are each one example of a “second pillar” according to the present disclosure. The third left pillar 16 and the third right pillar 19 are each one example of a “third pillar” according to the present disclosure.

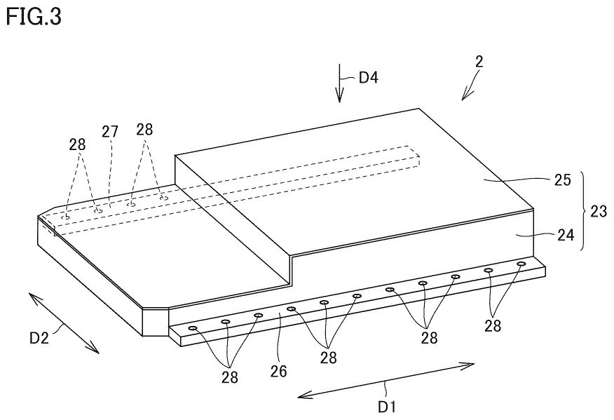

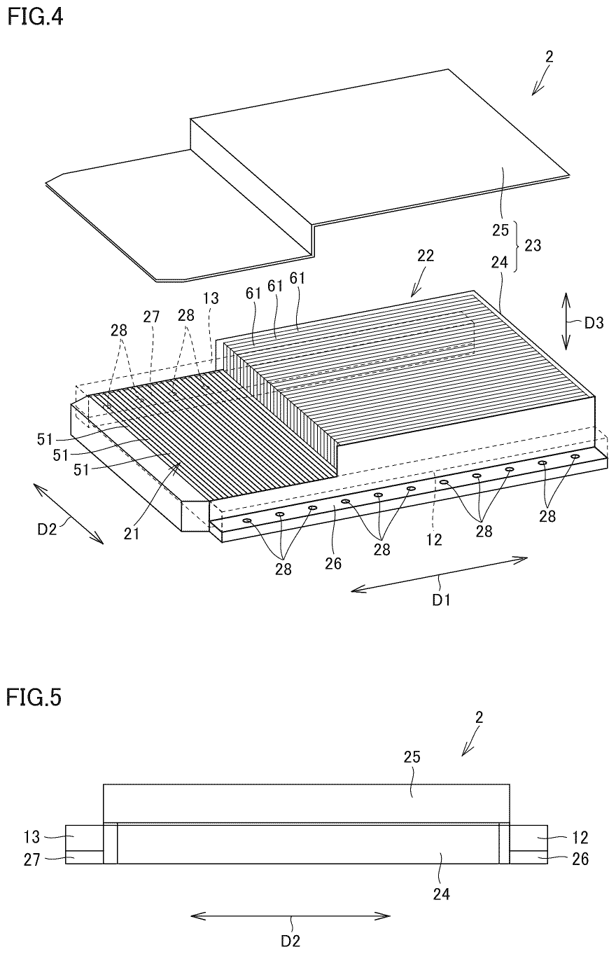

Referring, again, to FIG. 1, the power storage device 2 is provided on the vehicle frame 3. FIG. 3 is a first perspective view schematically showing the power storage device 2. FIG. 4 is a second perspective view schematically showing the power storage device 2. FIG. 4 shows the power storage device 2 having the upper case removed therefrom.

Referring to FIGS. 3 and 4, the power storage device 2 includes a power storage module 21, a power storage module 22, and a housing case 23. The power storage module 21 is one example of a “first power storage module” according to the present disclosure. The power storage module 22 is one example of a “second power storage module” according to the present disclosure.

The housing case 23 accommodates the power storage module 21 and the power storage module 22. The housing case 23 includes a lower case 24 and an upper case 25.

The housing case 23 further includes supports 26 and 27. The supports 26 and 27 are secured to the vehicle frame 3 (see FIG. 2). By way of example, the supports 26 and 27 have holes 28 into which bolt are fitted. As bolts are fitted into the holes 28, the support 26 is secured to the left frame 12 and the support 27 is secured to the right frame 13.

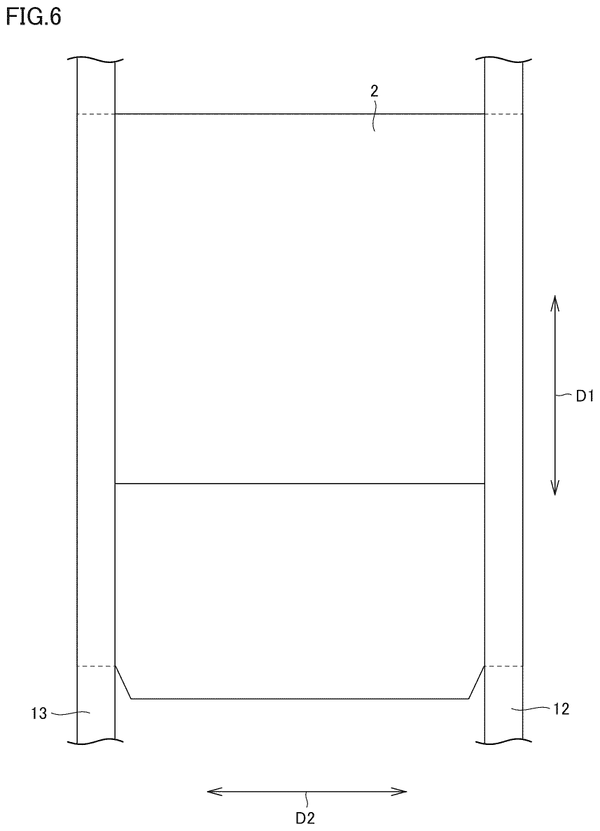

FIG. 5 is a diagram schematically showing the vehicle frame 3 and the power storage device 2 secured to the vehicle frame 3, as viewed from the front of the vehicle 1. FIG. 6 is a diagram schematically showing the vehicle frame 3 and the power storage device 2 secured to the vehicle frame 3, as viewed from the top (in a direction D4 shown in FIG. 3). As shown in FIGS. 5 and 6, the support 26 is secured to the lower surface of the left frame 12. The support 27 is secured to the lower surface of the right frame 13. In other words, the power storage device 2 is secured to the vehicle frame 3.

Referring, again, to FIG. 4, as the power storage device 2 is secured to the vehicle frame 3, the power storage module 21 is disposed between the left frame 12 and the right frame 13. More specifically, the power storage module 21 is disposed so that at least portions of the power storage module 21 overlap the left frame 12 and the right frame 13 when the power storage module 21 and the vehicle frame 3 are viewed from a side of the vehicle 1. In contrast, the power storage module 22 does not overlap the left frame 12 and the right frame 13 when the power storage module 22 and the vehicle frame 3 are viewed from a side of the vehicle 1.

The power storage module 21 includes multiple power storage cells 51. The power storage cell 51 is one example of a “first power storage cell” according to the present disclosure. The power storage cell 51 extends in the width direction D2 of the vehicle 1.

The power storage module 22 is disposed on the power storage module 21. In other words, in the vehicle 1, the power storage module 21 and the power storage module 22 are stacked in the up-down direction D3 of the vehicle 1. The power storage module 22 includes multiple power storage cells 61. The power storage cell 61 is one example of a “second power storage cell” according to the present disclosure. The power storage cell 61 extends in the front-rear direction D1 of the vehicle 1.

The power storage cell 51 and the power storage cell 61 are secondary batteries, representatively, lithium-ion secondary batteries. The lithium-ion secondary battery contains lithium as a charge carrier, and can include a general lithium-ion secondary battery whose electrolyte is a liquid, as well as what is known as an all-solid-state battery using a solid electrolyte. Note that the power storage cell 51 and the power storage cell 61 are not limited to lithium-ion secondary batteries, and may be configured with nickel-metal hydride secondary batteries or other secondary batteries.

The power storage cell 51 and the power storage cell 61 may have the same size or different sizes. The power storage cell 51 and the power storage cell 61 having the same size meets the following three conditions:
First condition: The length of the power storage cell 51 in the width direction D2 of the vehicle 1 is the same as the length of the power storage cell 61 in the front-rear direction D1 of the vehicle 1.
Second condition: The length of the power storage cell 51 in the front-rear direction D1 of the vehicle 1 is the same as the length of the power storage cell 61 in the width direction D2 of the vehicle 1.
Third condition: The length of the power storage cell 51 in the up-down direction D3 of the vehicle 1 is the same as the length of the power storage cell 61 in the up-down direction D3 of the vehicle 1.

In the present disclosure, “lengths being the same” means lengths being exactly the same, and lengths being substantially the same. In the present disclosure, the length being substantially the same means including some errors due to manufacturing variations, etc.

The power storage cell 51 and the power storage cell 61 being the same size facilitates the design of the power storage device 2.

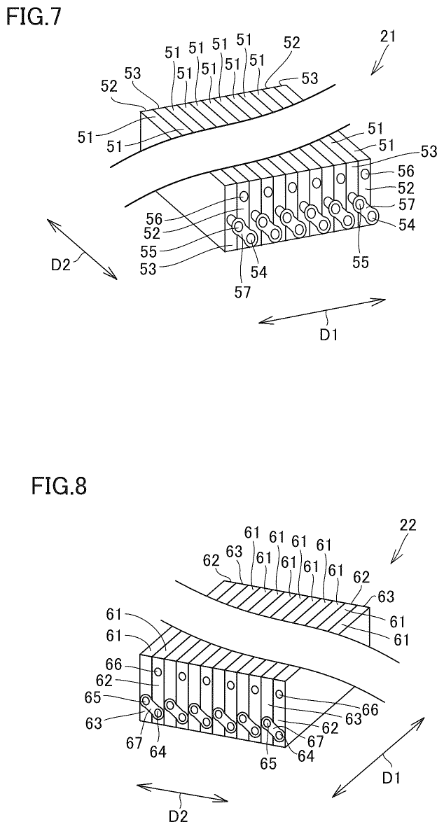

FIG. 7 is a diagram schematically showing one example of the power storage cells 51. The power storage cell 51 include an end surface 52 and an end surface 53. The end surface 52 and the end surface 53 are arranged spaced apart from each other in the width direction D2 of the vehicle 1. The end surface 52 is one example of a “first end surface” according to the present disclosure. The end surface 53 is one example of a “second end surface” according to the present disclosure. In the power storage module 21, the power storage cell 51 having the end surface 53 facing the left side of the vehicle 1 and the power storage cell 51 having the end surface 52 facing the left side of the vehicle 1 are alternately arranged along the front-rear direction D1 of the vehicle 1.

The power storage cell 51 includes a negative terminal 54 and an exhaust valve 56 in the end surface 52. The power storage cell 51 also includes a positive terminal 55 in the end surface 53. In other words, the negative terminal 54 and the exhaust valve 56 are provided in one end of the power storage cell 51 in the longitudinal direction, and the positive terminal 55 is provided at the other end of the power storage cell 51 in the longitudinal direction. The negative terminal 54 is one example of a “first external terminal” according to the present disclosure. The exhaust valve 56 is one example of a “first exhaust valve” according to the present disclosure. When the internal pressure of the power storage cell 51 increases, the exhaust valve 56 is configured to vent a gas out of the power storage cell 51.

A negative terminal 54 and a positive terminal 55 of adjacent power storage cells 51 are connected together by a bus bar 57 and multiple power storage cells 51 are, thereby, connected in series.

FIG. 8 is a diagram schematically showing one example of the power storage cells 61. The power storage cell 61 includes an end surface 62 and an end surface 63. The end surface 62 and the end surface 63 are arranged, spaced apart from each other in the front-rear direction D1 of the vehicle 1. The end surface 62 is one example of a “third end surface” according to the present disclosure. The end surface 63 is one example of a “fourth end surface” according to the present disclosure. In the power storage module 22, the power storage cell 61 having the end surface 63 facing forward of the vehicle 1 and the power storage cell 61 having the end surface 62 facing forward of the vehicle 1 are alternately arranged in the width direction D2 of the vehicle 1.

The power storage cell 61 includes a negative terminal 64 and an exhaust valve 66 in the end surface 62. The power storage cell 61 also includes a positive terminal 65 in the end surface 63. In other words, the negative terminal 64 and the exhaust valve 66 are provided in one end of the power storage cell 61 in the longitudinal direction, and the positive terminal 65 is provided at the other end of the power storage cell 61 in the longitudinal direction. The negative terminal 64 is one example of a “second external terminal” according to the present disclosure. The exhaust valve 66 is one example of a “second exhaust valve” according to the present disclosure. When the internal pressure of the power storage cell 61 increases, the exhaust valve 66 is configured to vent a gas out of the power storage cell 61.

A negative terminal 64 and a positive terminal 65 of adjacent power storage cells 61 are connected together by a bus bar 67 and multiple power storage cells 61 are, thereby, connected in series.

Referring, again, to FIG. 2, the front end portions of the power storage cells 61 of the power storage module 22 in the longitudinal direction are disposed to overlap the second left pillar 15 and the second right pillar 18 when the power storage module 22 and the vehicle frame 3 are viewed from a side of the vehicle 1. For the power storage cell 61 having the end surface 63 facing forward of the vehicle 1, the end surface 63 is the front end portion of the power storage cell 61 in the longitudinal direction. For the power storage cell 61 having the end surface 62 facing forward of the vehicle 1, the end surface 62 is the front end portion of the power storage cell 61 in the longitudinal direction.

The rear end portions of the power storage cells 61 in the longitudinal direction are disposed to overlap the third left pillar 16 and the third right pillar 19 when the power storage module 22 and the vehicle frame 3 are viewed from a side of the vehicle 1. For the power storage cell 61 having the end surface 63 facing forward of the vehicle 1, the end surface 62 is the rear end portion of the power storage cell 61 in the longitudinal direction. For the power storage cell 61 having the end surface 62 facing forward of the vehicle 1, the end surface 63 is the rear end portion of the power storage cell 61 in the longitudinal direction.

In this manner, the vehicle 1 according to the present embodiment includes the power storage device 2 which includes the power storage module 21 and the power storage module 22. The power storage module 21 is disposed between the left frame 12 and the right frame 13, and the power storage cells 51 included in the power storage module 21 extend in the width direction D2 of the vehicle 1. The power storage module 22 is disposed on the power storage module 21, and the power storage cells 61 included in the power storage module 22 extend in the front-rear direction D1 of the vehicle 1.

In the vehicle 1 according to the present embodiment, at least one of the negative terminal and the positive terminal is provided at one end of the power storage cell in the longitudinal direction. Therefore, the ends of the power storage cell in the longitudinal direction are required to be protected more than the ends of the power storage cell in the lateral direction. To this end, according to the vehicle 1 of the present embodiment, the left frame 12 and the right frame 13 protects the ends of the power storage cell 51 in the longitudinal direction from the impact applied from a side of the vehicle 1. Moreover, the negative terminal 54 and the exhaust valve 56 are provided in one end of the power storage cell 51 in the longitudinal direction, and the positive terminal 55 is provided at the other end of the power storage cell 51 in the longitudinal direction. Therefore, according to the vehicle 1 of the present embodiment, the left frame 12 and the right frame 13 protect the negative terminal 54, the positive terminal 55, and the exhaust valve 56 from the impact applied from a side of the vehicle 1.

Moreover, according to the vehicle 1 of the present embodiment, the power storage cells 61 are disposed so that the ends of the power storage cells 61 in the longitudinal direction do not face the sides of the vehicle 1. Therefore, even if an impact force is applied from a side of the vehicle 1, the impact force is unlikely to be applied to the ends of the power storage cells 61 in the longitudinal direction. The negative terminal 64 and the exhaust valve 66 are provided in one end of the power storage cell 61 in the longitudinal direction, and the positive terminal 65 is provided at the other end of the power storage cell 61 in the longitudinal direction. Therefore, according to the vehicle 1 of the present embodiment, even if an impact force is applied from a side of the vehicle 1, the application of the impact force to the negative terminal 64, the positive terminal 65, and the exhaust valve 66 can be suppressed.

Accordingly, according to the vehicle 1 of the present embodiment, not only the power storage module 21 overlapping the left frame 12 and the right frame 13 when the power storage device 2 and the vehicle frame 3 are viewed from a side of the vehicle 1, but also the power storage module 22 not overlapping the left frame 12 and the right frame 13 when the power storage device 2 and the vehicle frame 3 are viewed from a side of the vehicle 1 are protected from the impact applied from a side of the vehicle 1.

Note that the front end portion of the power storage cell 61 in the front-rear direction D1 of the vehicle 1 is located away from the front end portion of the vehicle 1. Owing to this, even if an impact force is applied to the front end portion of the vehicle 1, the application of the impact force to the front end portion of the power storage cell 61 is suppressed. Similarly, the rear end portion of the power storage cell 61 in the front-rear direction D1 of the vehicle 1 is located away from the rear end portion of the vehicle 1. Owing to this, even if an impact force is applied to the rear end portion of the vehicle 1, the application of the impact force to the rear end portion of the power storage cell 61 is suppressed.

Moreover, according to the vehicle 1 of the present embodiment, multiple power storage modules are stacked in the up-down direction D3 of the vehicle 1. Therefore, the limited space at the bottom of the vehicle 1 is effectively utilized, and the power storage device 2 having an increased capacity is implemented.

Moreover, in the vehicle 1 according to the present embodiment, the power storage module 22 is disposed so that the front end portion of the power storage cell 61 in the longitudinal direction overlaps the second left pillar 15 and the second right pillar 18 when the power storage module 22 and the vehicle frame 3 are viewed from a side of the vehicle 1. This protects the front end portion of the power storage cell 61 in the longitudinal direction from the impact applied from a side of the vehicle 1.

Moreover, in the vehicle 1 according to the present embodiment, the power storage module 22 is disposed so that the rear end portions of the power storage cells 61 in the longitudinal direction overlap the third left pillar 16 and the third right pillar 19 when the power storage module 22 and the vehicle frame 3 are viewed from a side of the vehicle 1. This protects the rear end portion of the power storage cell 61 in the longitudinal direction from the impact applied from a side of the vehicle 1.

While the power storage module 21 includes multiple power storage cells 51 in the above embodiment, the power storage module 21 may include at least one power storage cell 51.

While the power storage cells 51 extend in the width direction D2 of the vehicle 1 in the above embodiment, the power storage cells 51 may extend in the front-rear direction D1 of the vehicle 1.

While the power storage module 22 includes multiple power storage cells 61 in the above embodiment, the power storage module 22 may include at least one power storage cell 61.

The front end portion of the power storage cell 61 in the longitudinal direction may not overlap the second left pillar 15 and the second right pillar 18 when the power storage module 22 and the vehicle frame 3 are viewed from a side of the vehicle 1. The rear end portion of the power storage cell 61 in the longitudinal direction may not overlap the third left pillar 16 and the third right pillar 19 when the power storage module 22 and the vehicle frame 3 are viewed from a side of the vehicle 1.

### [Variation 1]

In the above embodiment, the negative terminal 54 and the exhaust valve 56 are provided in one end of the power storage cell 51 in the longitudinal direction, and the positive terminal 55 is provided at the other end of the power storage cell 51 in the longitudinal direction. However, the negative terminal 54, the positive terminal 55, and the exhaust valve 56 may be provided in at least one end of the power storage cell 51 in the longitudinal direction. For example, the negative terminal 54, the positive terminal 55, and the exhaust valve 56 may be provided only in one end of the power storage cell 51 in the longitudinal direction.

More specifically, the power storage cell 51 includes: two end surfaces, which are spaced apart from each other in the width direction D2 of the vehicle 1; the negative terminal 54; the positive terminal 55; and the exhaust valve 56. The negative terminal 54, the positive terminal 55, and the exhaust valve 56 may be provided in only one of the two end surfaces. In that case, all the power storage cells 51 included in the power storage module 21 are arranged so that the end surface, at which the negative terminal 54, the positive terminal 55, and the exhaust valve 56 are provided, faces the left side of the vehicle 1. Alternatively, all the power storage cells 51 included in the power storage module 21 are arranged so that the end surface, at which the negative terminal 54, the positive terminal 55, and the exhaust valve 56 are provided, faces the right side of the vehicle 1. A negative terminal 54 and a positive terminal 55 of adjacent power storage cells 51 are connected together by the bus bar 57 and multiple power storage cells 51 are, thereby, connected in series.

Even in such a case, the left frame 12 and the right frame 13 protect the negative terminal 54, the positive terminal 55, and the exhaust valve 56 from the impact applied from a side of the vehicle 1.

### [Variation 2]

In the above embodiment, the negative terminal 64 and the exhaust valve 66 are provided in one end of the power storage cell 61 in the longitudinal direction, and the positive terminal 65 is provided at the other end of the power storage cell 61 in the longitudinal direction. However, the negative terminal 64, the positive terminal 65, and the exhaust valve 66 may be provided in at least one end of the power storage cell 61 in the longitudinal direction. For example, the negative terminal 64, the positive terminal 65, and the exhaust valve 66 may be provided only in one end of the power storage cell 61 in the longitudinal direction.

More specifically, the power storage cell 61 includes: two end surfaces, which are arranged spaced apart from each other in the front-rear direction D1 of the vehicle 1; the negative terminal 64; the positive terminal 65; and the exhaust valve 66. The negative terminal 64, the positive terminal 65, and the exhaust valve 66 may be provided in only one of the two end surfaces. In that case, all the power storage cells 61 included in the power storage module 22 are arranged so that the end surface, at which the negative terminal 64, the positive terminal 65, and the exhaust valve 66 are provided, faces forward of the vehicle 1. Alternately, all the power storage cells 61 included in the power storage module 22 are arranged so that the end surface, at which the negative terminal 64, the positive terminal 65, and the exhaust valve 66 are provided, faces backward of the vehicle 1. A negative terminal 64 and a positive terminal 65 of adjacent power storage cells 61 are connected together by the bus bar 67, and multiple power storage cells 61 are, thereby connected in series.

Even in such a case, the negative terminal 64, the positive terminal 65, and the exhaust valve 66 are protected from the impact applied from a side of the vehicle 1.

### [Variation 3]

The power storage device 2 has two power storage modules (the power storage module 21 and the power storage module 22) in the above embodiment. However, the power storage device 2 may include three or more power storage modules. In that case, two or more of the three or more power storage modules may be stacked in the up-down direction D3 of the vehicle 1. At least one of the three or more power storage modules may be configured and disposed in the same manner as the power storage module 21, and the rest of the three or more power storage modules may be configured and disposed in the same manner as the power storage module 22.

While the embodiment according to the present disclosure has been described above, the embodiment presently disclosed should be considered in all aspects illustrative and not restrictive. The scope of the present disclosure is defined by the appended claims. All changes which come within the meaning and range of equivalency of the appended claims are to be embraced within their scope.

What is claimed is:

1. A vehicle, comprising:
a vehicle frame; and
a power storage device provided on the vehicle frame, wherein
the vehicle frame includes a first frame and a second frame which is disposed, spaced apart from the first frame in a width direction of the vehicle,
the first frame and the second frame extend in a front-rear direction of the vehicle,
the power storage device includes a first power storage module which includes a first power storage cell, and a second power storage module which includes a second power storage cell, the second power storage module being disposed on the first power storage module,
the first power storage module is disposed between the first frame and the second frame,
the first power storage cell extends in the width direction of the vehicle,
the first power storage cell includes a first end surface and a second end surface, which are arranged, spaced apart from each other in the width direction of the vehicle, and a first external terminal provided at the first end surface,
the second power storage cell extends in the front-rear direction of the vehicle, and
the second power storage cell includes a third end surface and a fourth end surface, which are arranged, spaced apart from each other in the front-rear direction of the vehicle, and a second external terminal provided at the third end surface.

2. The vehicle according to claim 1, wherein
the vehicle frame includes:
a first pillar connected to the first frame;
a second pillar disposed behind and spaced apart from the first pillar and connected to the first frame; and
a third pillar disposed behind and spaced apart from the second pillar and connected to the first frame, wherein
when the second power storage module and the vehicle frame are viewed from a side of the vehicle, a front end portion of the second power storage cell overlaps the second pillar.

3. The vehicle according to claim 1, wherein
the vehicle frame includes:
a first pillar connected to the first frame;
a second pillar disposed behind and spaced apart from the first pillar and connected to the first frame; and
a third pillar disposed behind and spaced apart from the second pillar and connected to the first frame, wherein
when the second power storage module and the vehicle frame are viewed from a side of the vehicle, a rear end portion of the second power storage cell overlaps the third pillar.

4. The vehicle according to claim 1, wherein
the first power storage cell and the second power storage cell have a same size.

5. The vehicle according to claim 1, wherein
the first power storage cell further includes a first exhaust valve provided in the first end surface, and
the second power storage cell further includes a second exhaust valve provided in the third end surface.
